(19) United States
(12) Patent Application Publication
(10) Pub. No.: US 2002/0116504 A1
(43) Pub. Date: Aug. 22, 2002

(54) Software component for a distributed control system, and method for designing a control system

(76) Inventors: Otto Preis, Zeihen (CH); Maren Eschermann, Untersiggenthal (CH); Martin Naedele, Zurich (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/075,603

(22) Filed: Feb. 15, 2002

(30) Foreign Application Priority Data
Feb. 16, 2001 (EP) 01810160.0

(51) Int. Cl. G06F 15/16; G06F 15/173

(52) U.S. Cl. 709/227; 709/223

(57) ABSTRACT

The object of the invention is to provide a software component (1, 2, 3) for a distributed control system having application units (4, 5) which have one or more logic function nodes which each define an individual control system function in the application units and interact with one another, or can interact with one another, in order to achieve a desired functionality for the control system; having a function means for implementation of a logic function node; a negotiation means for receiving a connection instruction relating to a connection to be set up to at least one further function node and for agreeing upon possible usable connection parameters between the function node and the at least one further function node during a composition phase of the control system; and a connection means for setting the negotiated connection parameters between the function means and for data transmission between the connected function means during a runtime of the control system.

### TECHNICAL FIELD

The invention relates to a software component for application units in control systems, for example for process control technology, to a control system which uses such software components, to a method and to a computer program product for designing a control system.

### PRIOR ART

Plant control technology systems such as those which are used in power generating plant and distribution stations, and high-voltage and medium-voltage switchgear assemblies, generally comprise a system of mutually networked components, which produce the overall functionality of the system. These components are referred to as application units in the present invention.

An application unit may be an appliance, for example a controller or instrument, or a program which runs on a data processing system. Application units are also referred to as intelligent electronic devices. Station control technology systems such as these have a high degree of networking, since the application units have to interact with one another. The software functionality of the application unit can in this case be logically subdivided into elementary function nodes, which each define an individual function of the application unit. Examples of function nodes such as these may be switch control functions, protection functions (for example against overcurrent), archiving functions for measured values or for other system conditions, etc., but also the process interfaces, which are mapped in proxies, for the physical equipment. In order to achieve the desired overall functionality of a control station, these function nodes are logically-functionally connected to one another. Thus, for example, a switch controller can be connected to a switch representation (which switches it) in a control station program, or a temperature sensor may be connected to a temperature indicating component. In modern plant control technology systems, appliances based on data processing are used virtually exclusively. The function nodes implemented in these appliances consist of program objects which run on a microcontroller or on a similar unit, and which produce the actual actuation of the physical elements and/or the display of information or user interfaces.

Thus, in this context, the definition of a function node does not include a physical element (if any such element is present at all), but software that controls it.

Intelligent electronic appliances for plant control technology generally contain a large number of such function nodes. This also applies to the data processing systems used to provide switching control centers or the like and on which numerous software objects run, which implement a user interface, frequently in the form of graphics.

The various application units in a system are connected to one another via physical connections, for example networks or data buses, in order to allow them to communicate with one another via these networks or data buses. Between the logical function nodes in these application units, logical connections are set up and are established via physical connections.

In order to transmit data between the application units or the function nodes implemented in them, connection parameters are taken into account which can understand in a corresponding manner the function nodes which communicate with one another, and which must either be defined in advance or can be agreed upon in a negotiation phase between the function nodes. Connection parameters may, for example, be coding and the speed of the transmitted data, or else the significance of the data with regard to its correct interpretation.

In order to allow the complex interaction between the various application units, even when produced by different manufacturers, or to achieve further improvements, it appears to be worthwhile to standardize the functionality and communication capability of the function nodes. IEC have carried out this task with the development of IEC Standard 61850. This Standard describes the logical and physical construction of application units specifically for station control technology, and provides a breakdown into functional components in order to solve the problems relating to data interchange and communication between application units.

In the data model defined in Part 7 of the Specification, an intelligent electronic appliance (which is equivalent to an application unit for the purposes of the present invention) interacts via an ACSI (Abstract Communication Service Interface) with other application units. The intelligent electronic appliance can be subdivided into a number of servers, which themselves contain logical appliances. These logical appliances may in turn each have one or more so-called logical nodes, whose concept corresponds to the function nodes of the present invention.

Logical nodes are the primary concept in the IEC Standard. These represent the smallest functional units which can be implemented such that any logical distinction is feasible at all. Normal functions of a control station comprise at least three logical nodes, a logical node for the core functionality, one for the process interface and one for the HMI (human machine interface)-related part. While IEC 61850 has the aim of making it possible to ensure functionality, communication and compatibility of application units, the specific implementation of the model proposed in IEC 61850 is left to the individual providers of application units for station control technology.

Distributed control systems such as these, for example substation automation systems, are programmed in the prior art by software engineers using either a procedural approach or an approach based on object orientation. In this case, distributed substation automation applications are constructed by producing proprietary individual program objects or by reusing them, in the case of libraries.

In this case, each application unit contains a type of database. For example, in the case of appliances based on IEC Standard 61850, each logical node has a logical database. The data interchange between the program objects, for example those for implementing function nodes, is achieved by transferring individual signals/variables to these databases. This thus represents a data-flow-centered approach, which requires the configuration of a distributed database system, which must be consistent with regard to the data communication devices, between its distributed components. However, such functionality distribution invariably leads to a low abstraction level for the implementation. This has various disadvantages:

The abstraction models and thus their mapping onto the communications system differ between application units from different manufacturers and even between ranges of products from one individual manufacturer, and this leads to a high level of complexity for the programming of a system.

The consistent configuration of the various databases together with the communication system is time-consuming and susceptible to errors, which decreases the quality and can increase costs.

Furthermore, each system produced in this way has a unique construction and, owing to the lack of standardization, cannot be tested well and is difficult to maintain, which in turn reduces the quality and increases the costs.

Despite modeling in accordance with IEC Standard 61850, manufacturer independence is also difficult to achieve during the programming phase, and this once again leads to higher costs.

### DESCRIPTION OF THE INVENTION

The object of the present invention is thus to provide a higher abstraction level for application programming for control systems.

According to the invention, this object is achieved by providing a software component as claimed in the independent patent claim 1, by providing a control system having a number of software components as claimed in the independent patent claim 11, by using software components for representation of function nodes as claimed in the independent patent claim 14, by the method for designing a control system as claimed in the independent patent claim 15, and by the computer program product as claimed in the independent patent claim 16.

Further advantageous refinements, details and aspects of the present invention can be found in the dependent patent claims, in the description and in the attached drawing.

The invention is based on the idea of formalizing the function nodes for the application units, of providing them as software components, and hence of encapsulating the nodes with them.

It is thus an object of the invention to provide a software component for a distributed control system having application units which comprises one or more logic function nodes which each define an individual monitoring function in the application units and, in order to achieve a desired functionality for the control system, interact with one another, or can interact with one another; with the software component having:

a function means for implementation of a logic function node;

a negotiation means for receiving a connection instruction relating to a connection to be set up with at least one further function node and for negotiating possible usable connection parameters between the function node and the at least one further function node during a composition phase of the control system; and

a connection means for setting the connection parameters agreed upon between the function means and for data transmission between the connected function means during a runtime of the control system.

Component-based software production is one of the most recent developments in the production of large software systems and, in particular, in the development of application software. It can be regarded as a successor or a further development of the object-oriented paradigm. Component-based software development is based on the idea of constructing applications by assembling pre-fabricated software components in a black-box manner. For the purposes of the present invention, a software component is a compositional unit of contractually specified interfaces and exclusively explicit context dependencies. A software component can be distributed, and can be used by third parties for their compositions, independently. A software component can thus be regarded as a static abstraction with connectors. Connectors relate to the incoming and outgoing interfaces. The static aspect of a software component allows components to be stored in storage locations.

The above description of the term software component will be used in the present invention. A software component thus consists of an encapsulated functionality with defined interfaces, which can be regarded as an entity. The stated definitions correspond to their use in known modern component technologies such as COM/COM+ from Microsoft or “Enterprise Java Beans” (EJB) from Sun, and in their implementation of software components.

For the purposes of the present invention, an application unit may be regarded as any functional entity which can be used in a control system. In particular, application units may be intelligent electronic appliances which are used for switching technology and which may contain switches, sensors, microprocessors, etc. An application unit may also be a pure software object which runs, for example, in a normal data processing system, all or part of whose computation power is integrated in the control system.

A control system should be regarded as a system of components as well as application units whose interaction makes it possible to control processes. Processes may be production or distribution of goods or distribution of power, controlling of transport systems, etc.

A distributed control system is one in which the application units are not all accommodated at the same location or physically in one housing, but which is distributed over an spatial area, making it necessary for the appliances or application units to communicate via physical interfaces.

A logic function node may be regarded as the smallest possible functional structure within an application unit. The concept of such a logic function node essentially corresponds to the definitions in IEC Standard 61850, whose definition of logical nodes is thus referred to. The term “logic” in the context of a function node means that the function node need not represent a cohesive physical unit, but is defined only by the logical relationship of its components and by its functionality.

According to the invention, the software component consists of three sub-units, namely a function means, a negotiation means and a connection means. In this case, as a software object, the function means provides the actual functionality (function logic) of the function node. For example, it implements any database that is required and can establish the physical connection to hardware components in the application unit, provided this is allowed by a framework used in the application unit. If not, it can access the framework, in order to monitor the actual hardware. If the application unit is implemented purely in the form of software, the function means may be a program object which can indicate the functionality desired by the application unit, for example the indication of a value measured by a sensor.

The software component comprises two further means, which considerably simplify the development and use of control systems. These are, firstly, the negotiation means which is used in a composition phase of the control system and, secondly, the connection means, which is used during the runtime of the control system. The negotiation means provides the functionality/program logic required for the composition of the control system. The negotiation means is firstly used to inform the software component that it is intended to enter into a connection with at least one further function node, for example connection of a switch function node to a switch relay function node. Secondly, the negotiation means is used to find out how a specific communication can be carried out between the function nodes to be connected. Sets of connection parameters are defined for this purpose which must be compatible for the function nodes which are to be connected to one another.

The implementation of the negotiation means represents a central element of the invention. This is because the negotiation means carries out the tasks which the developer of the control system has to carry out when using conventional programming approaches and abstracts all aspects of the actual setting up of a connection as far as the level at which the developer now just has to enter his connection request, with the negotiation means of the software components to be connected automatically finding out the configuration that is actually to be implemented and initiating this by transferring parameters to the connection means. In carrying out this task, the negotiation means may possibly be supported by a database with predetermined information relating to the software component, for example relating to a compatibility group (only within which connection between software components is possible) or relating to the format and content of the information to be transmitted. The negotiation means in this case may take into account, for example, the following criteria for determining a valid connection:

1. The function type compatibility between the source and sink. A source is in this case a function node which transmits information, while a sink is a function node which receives information. One function node may also have both tasks in one connection, although they must each be regarded separately. Function types means units whose values are intended to be transmitted, for example the detection of a temperature or the provision of archiving functions. The only function nodes which can communicate with one another are those which are compatible in this case. For example, an archiving function is generally compatible with a measurement sensor controller which transmits measured values at regular intervals but, for example, would be incompatible with a function for actuating tape drive mechanisms.

2. The data type compatibility between the source and sink. This means information data types such as integer or floating point as well as physical data types such as V or kV. A function node which carries out calculations in kV cannot be fed from a source which exports its voltage values in V. However, one task of the negotiation means may also be, for example, to configure the source such that the voltage details are given in a format which is legible by the sink, provided the source can be configured appropriately.

3. The availability of the communications resources on the path between the source and sink. Compatibility must also be ensured here, for example with regard to the availability of shared memories or of suitable network paths such as LANs (local area networks) or telephone lines. Both function nodes to be connected must be able to access suitable, matching communications resources.

4. Consideration of system qualities, where specified. This includes, for example, the availability of an appliance (its reliability, for example as a percentage), permissible response times to questions, the amount of data which can be processed per unit time, etc. A composition of function nodes can also be checked for validity with regard to these factors.

Further criteria for the compatibility or matching of function nodes may occur in addition, so that the categories mentioned above should not be regarded as being limiting, but as exemplary.

The negotiation means preferably has a composition interface for communication with a control system composition tool for receiving the connection information, and a system interface for communication with other software components during a negotiation phase. The composition interface thus serves for transmitting information from a control system composition tool. A composition tool such as this, which is also referred to as a builder, represents the communication frame in which the negotiation means of the various software components in the control system to be established can move. The composition tool may be designed in various, pronouncedly different ways. For example, it is feasible to use a composition tool which is a simple command line program, into which the identifiers of the software components to be connected can enter, possibly together with further frame conditions for the connection, via a text terminal. A composition tool may, however, also be a highly complex graphics instrument, which allows the software components to be connected to be manipulated directly on the screen, in two-dimensional or three-dimensional graphics form, by means of modern control devices such as a mouse or voice input.

Furthermore, the negotiation means preferably has a system interface, which serves for direct communication between the various software components. A negotiation means which, for example, has been informed via the composition interface that it is supposed to establish a connection to a specific other function node, or to its software components, can address this function node via said function node's system interface and, during the negotiation phase, can find out whether communication between the two or more software components is possible. In this context, it is also possible to use the composition interface to transmit connection information from the software component to the composition tool, for example in order to inform the latter that a connection has been made, or that this connection is impossible, for incompatibility reasons.

A further element of the software component according to the invention is the connection means. This carries out the task of the actual communication between the various function nodes, or the software components. For this purpose, communication is established by the connection parameters being set in accordance with the prerequisites agreed upon, in order to carry out communication using these connection parameters, and, secondly, the connection means carries out the actual data transmission between the connected function nodes.

The connection means may be characterized in that the connection means comprises a runtime interface which serves for data transmission between the connected function nodes. In the present case, this will be referred to as a runtime interface, since it is used only during a runtime of the software component, but not in the composition of the control system.

The software component according to the invention is an entity which has available a combined functionality by means of which a control system can be both composed and operated. Each software component contains the necessary means to make it possible to use it to carry out a composition of a control system since, on the one hand, it can interact with a composition tool and can make autonomous decisions on possible communications with other software components while, on the other hand, it can also produce the actual connection between the function at runtime.

A further option for expanding the software component according to the invention is the integration of a representation means for displaying the function node, which is implemented by the software component, in a control system composition tool. The representation means may be configured as a component of the connection means, or may be an autonomous unit. The representation means in this case provides a functionality which allows the composition tool to produce a graphics representation of the function node on a screen. This may be, for example, a program object which is capable of displaying a symbol or a data list on a screen, representing the function node. Thus, for example, conventional circuit symbols, for example the symbol for a valve in the case of liquid control systems can be used in order to display the individual function nodes. Additional information, such as type identifiers or specific capabilities of the function node, may be added as well. Furthermore, it is likewise possible to configure the representation means such that, in addition to the actual display of the function node, it is also capable of displaying a current state of the function node. To do this, the representation means must have access to information relating to the function node, for example by accessing a database with such information or by interacting with the function means. An embodiment such as this may be of particular interest if either the composition tool likewise has a runtime representation, so that it can be used not only for composition but also for monitoring the control system that is established, or an autonomous system which is capable of operating with the same software components and/or the identical interfaces of these software components as the composition tool, is provided for monitoring the control system at runtime.

The text so far has described the logical structure of the software component according to the present invention. However, no description has yet been given of how the relationship between the logical structure and a physical implementation may look like.

Numerous options for the actual implementation of a software component are available to a person skilled in the art. For example, all the elements of the software component, that is to say the function means, the negotiation means and the connection means, may be accommodated jointly in one intelligent electronic appliance, which can run the software component by means of a microprocessor. The communication with the composition tool and between the software components can then take place via physical interfaces between the various application units or, if the software components that are connected to one another are accommodated in the same application unit, via logical interfaces within the appliance.

However, it is also possible for the software components as such to be already distributed without departing from the concept of the software component being represented as a closed entity. Thus, for example, the software component may be a distributed system in which the function means and connection means are separated from the negotiation means. The function means and the connection means may, for example, be accommodated in one intelligent electronic appliance, while the negotiation means runs, for example, on a data processing appliance, wherein the composition tool runs on the same data processing appliance.

The various software components can interact with one another due to the fact that, for example, the runtime interface of one software component may be connected via a network structure to runtime interfaces of other software components. One such network structure may, for example, be a data bus or a conventional data processing network such as the Ethernet or Token-Ring, to which the various application units or data processing appliances on which software application units can be run are connected.

A further necessity for the implementation of the software component according to the invention is that the connection means can be informed of the connection parameters which have been agreed upon by the negotiation means. This may be done, for example, by means of a database which may be accessed by both means. However, particularly in the case of distributed software components, that is to say in the case of software components in which the means according to the invention are not all accommodated in the same physical appliance, it is preferable for the software component to have a communication channel between the connection means and the negotiation means for transmission to the connection means of the connection parameters which have been agreed upon by the negotiation means. The actual implementation of such a communications channel would depend on the specific configurations of the software component, and is familiar to a person skilled in the art.

The definition of the function nodes used according to the invention is not restricted to any specific implementation. In fact, with regard to the invention, it is of primary importance that the definition of the function nodes allows the overall functionality of the control system, and/or of its individual application units, to be subdivided in order in this way to allow the control system to be composed in as flexible and versatile a way as possible. However, in order to ensure as much standardization of function nodes as possible and to minimize the complexity for the definition of the function nodes to be used, it is particularly preferable for the function nodes to be logical nodes in the sense of IEC Standard 61850.

The function means may, furthermore, have a database for storing parameters relating to the function node and/or relating to possible connections. This database—which, for example, can be produced in the form of a text file or an XML file—thus on the one hand makes it possible for the function means to communicate its present status as well as possible status changes, on the other hand, also allows information to be stored which may define the other function nodes to which the function means may be connected. Typical entries in the database would, for example, be the switching state of a switch, which is implemented by the function means, or the temperature currently measured by a sensor represented by the function means.

It is further an object of the invention to provide a control system having a number of software components according to the invention, having a control system composition tool for connecting negotiation means of the software components and having a communication system for connecting the connection means of the software components during a runtime. The communication system for connecting the connection means may be a network or a data bus. However, it may also be a logical connection, if the two or more software components which communicate with one another reside in the same application unit or in the same data processing system, part of said data processing system representing an application unit. A communications system such as this or a comparable communications system may also be necessary in order to connect the negotiation means to one another or to the composition tool. This is particularly the case if the negotiation means are located, combined with the connection means, in the application units so that a distributed system already exists with regard to the negotiation components and the composition tools.

It is, in addition, an object of the invention to permit the use of software components for representation of function nodes of application units of a control system with the function nodes each defining an individual control system function in the application units and, in order to achieve a desired functionality of the control system, interact with one another, or are capable of interacting with one another.

Use of software components for this area of data processing has not yet been disclosed.

It is further an object of the invention to provide a method for designing a control system having the following steps:

In a control system composition tool, connecting the negotiation means of at least two software components, whose function means are intended to interact with one another;

By means of the connected negotiation means, determining the compatibility of the at least two function means, which are intended to interact with one another;

Agreeing upon usable connection parameters for data transmission between the function means by means of the connected negotiation means;

Transferring the connection parameter information to the connection means; and

Connecting the connection means on the basis of the connection parameter information.

With regard to the advantages and further aspects of the method according to the invention, reference is also made to the entire contents of the description of the software component according to the invention, since many aspects of this method according to the invention have already been described there. The various steps according to the invention lead to a control system which is composed and is operable in accordance with the settings made by the compositor (programmer), since the connection means have already established connection on completion of the method according to the invention.

The definition of the compatibility and the negotiation of connection parameters—these two steps may also be combined or may be regarded as one step if, for example, the testing of the compatibility can implicitly be carried out by the success or failure of the negotiation of connection parameters—is the most complicated part of the method since, as stated above with regard to the description of the software component according to the invention, all possible cases of connection of function nodes that may be desired by the programmer must be taken into account in the functionality implemented here.

The transfer of the connection parameter information may be carried out directly via a communications channel or indirectly by storing the information in a location (database, memory location) which can also be accessed by the connection means.

The method may preferably be characterized in that the negotiation means are connected by means of a graphics user interface which can display representations of the function nodes and connections established between them. This makes it particularly simple to use graphical tools to carry out the composition of the control system in a data processing system.

Finally, it is an object of the invention to provide a computer program product which can be loaded into an internal memory of a digital data processing means and comprises computer program code means, which carry out the method according to the invention when they are loaded and executed on one or more data processing means. The computer program product thus describes and/or implements the software component according to the invention. The computer program product preferably comprises a computer-legible medium with a computer program stored in it, for carrying out the method according to the invention.

The software component according to the invention and the overall control system according to the invention as well as the method have a number of advantages, which improve manufacturer-independent implementation of control systems. The control system functionality is thus broken down into well-defined pieces. Software composition abstractions can support this decomposition process. Correlation of the function nodes according to the invention with logical nodes from IEC 61850 would ensure a connection between the model that is used and important information technology standards and technologies.

Application development and customer-specific adaptation can be achieved at the abstraction level of these software components, so that the tedious programming at a lower abstraction level, as was known in the prior art, is no longer required. The availability of a graphical composition model in certain embodiments also further simplifies the composition of control systems. In addition, the graphical composition is in practice possible only by abstraction at the software component level. This allows flexible, modular expansion of control systems, without any need to dispense with a graphical representation.

### BRIEF DESCRIPTION OF THE DRAWINGS

FIG. 1 shows the composition of a control system by connecting its components by means of a composition tool.

### WAYS TO IMPLEMENT THE INVENTION

As explained above, the functional decomposition of the overall functionality into function nodes as has, for example, already been carried out in IEC Standard 61850, is intended to be used as the basis for definition of atomic units, on whose basis control system applications can be assembled. The object model which is used and the concept of function nodes is in this case intended to be mapped onto software components. The concept of the function nodes, for example of the logical nodes from IEC 61850, is intended to be used in order to define the following key characteristics of the software component framework:

a component type system which is specific to the control system;

the functionality of the component runtime interfaces; and

the provided and required Quality of Service Standards (for example by using the Picom concept from IEC 618510).

A software component for mapping a function node encapsulates the functional response and the supported data types in this function node. The software component according to the invention supports two different types of response, namely, firstly, a composition time response and, secondly, a runtime response. Preferably, existing composition time interfaces such as the composition interface or the system interface assist the application composition and the component configuration, while the runtime interfaces provide the component interaction on the target hardware during the runtime of the control system.

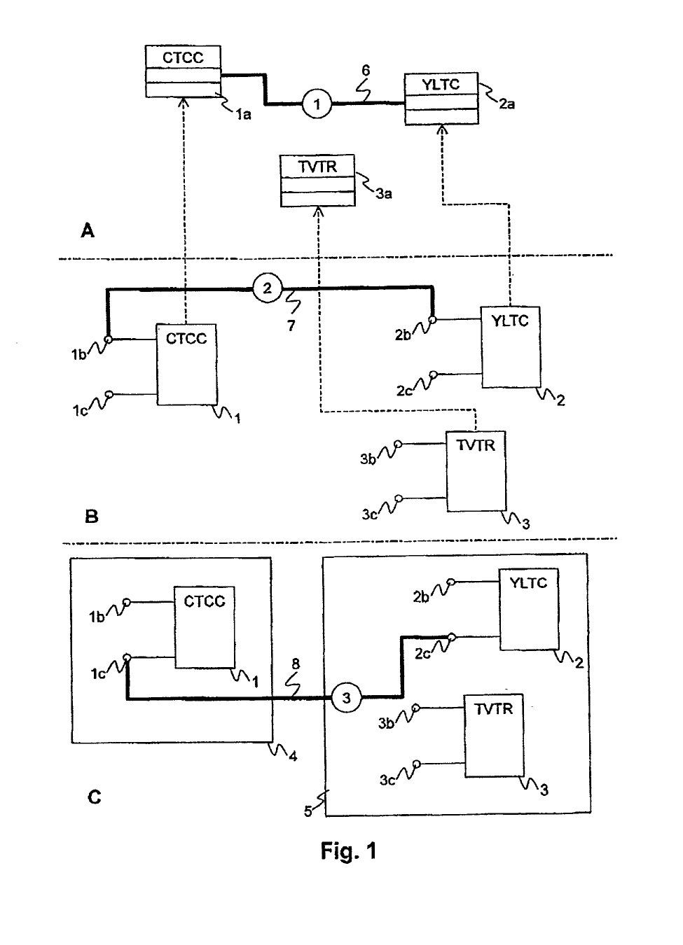

FIG. 1 shows the principle of the software component according to the invention and of the establishment of control systems by means of the software components according to the invention, illustrated schematically. FIG. 1 shows three software components 1, 2 and 3, which implement different function nodes for the control system to be produced. In this case, the software component, or at least its connection means, is provided in one application unit 4, while the two software components 2 and 3 are accommodated in a further application unit 5. The software components are provided, for illustrative purposes, with designations which correspond to the definitions in IEC 61850. The software component CTCC in this case represents a branch controller, the component YLTC represents a stepping switch, and the component with the designation TVTR implements a voltage converter, in IEC 61850. FIG. 1 shows three different levels of interaction between the software components. The uppermost level, separated by a dashed line, shows a user level A, within which the user graphically manipulate the software components. The middle level is a component level B during the composition time. Lastly, the level illustrated in the lower area of FIG. 1 represents a component level C during the runtime of the control system. The graphics representations 1a, 1b, 1c may, for example, be displayed within a window or on a screen of the composition tool. They are displayed by means of the software components 1, 2, 3 as is symbolized by the dashed arrows which extend from the component level B to the user level A. Each software component has at least one interface 1b, 2b, 3b, and these are used as system interfaces for communication between the negotiation means of the individual software components. The software components 1, 2, 3 furthermore have runtime interfaces 1c, 2c, 3c, which establish the actual connections during the runtime and provide the communication between the software components during the runtime.

By way of example, the establishment of a connection between two software components will be described in the following text, with reference to the illustration in FIG. 1. The construction of a customer-specific process control application is achieved by manipulation of the graphical representations 1a, 2a, 3a of the software components at the user level A, for example by connecting components by means of a drawing tool in the control system composition tool. In FIG. 1, this is shown by the thick line 6 as Step (1). This line is also displayed within the screen display of the composition tool. In this way, the developer just needs to manipulate his function nodes, which are well known to him, for example logical nodes in accordance with IEC Standard 61850. The options for graphical manipulation are defined, preset and supported by the system interfaces 1b, 2b, 3b, corresponding to the semantics for the connection of components of this type. The effect of the visual manipulation at the user level A is to set up the negotiations between the two components to be connected via the system interfaces 1b and 2b, as is shown by the line 7, as Step (2), at the component level B. The negotiation means influence the desired runtime response of the components, so that the runtime interfaces 1c, 2c can be configured automatically, as is indicated by the line 8 (Step (3)) in FIG. 1.

Complicated as the actual connection between the two function nodes may be (due to the distribution and hence localization of the function nodes in the application units and the actual application unit communication), this complexity is concealed from the application programmer, who can thus concentrate on the structuring of the control system and hence on achieving the intended functionality. The approach according to the invention for development of control systems is thus a) generic and standard; b) at a high abstraction level and c) applicable to all systems which use data communication between function nodes by means of various means, such as distributed databases or direct “remote procedure calls”.

List of Reference Symbols

1, 2, 3 Software components (SK)

1a, 2a, 3a Representation means of the software components

1b, 2b, 3b System interfaces of the software components

1c, 2c, 3c Runtime interfaces of the software components

4 First application unit

5 Second application unit

6 Connection between software components in the composition tool

7 Connection of two system interfaces during the composition process

8 Connection of two runtime interfaces during the runtime

1. A software component (1, 2, 3) for a distributed control system having application units (4, 5) which comprise one or more logic function nodes which each define an individual control system function in the application units and, in order to achieve a desired functionality for the control system interact with one another, or are capable of interacting with one another; said software component comprising:
a function means for implementation of a logic function node;
a negotiation means for receiving a connection instruction relating to a connection to be set up to at least one further function node and for agreeing upon possible usable connection parameters between the function node and the at least one further function node during a composition phase of the control system; and
a connection means for setting the connection parameters agrred upon between the function means and for data transmission between the connected function means during a runtime of the control system.

2. The software component as claimed in claim 1, characterized in that the negotiation means has a composition interface for communication with a control system composition tool for receiving the connection information; and
a system interface (1b, 2b, 3b) for communication with other software components during the negotiation.

3. The software component as claimed in claim 1 or 2, characterized in that the connection means has a runtime interface (1c, 2c, 3c) for data transmission between the connected function nodes.

4. The software component (1, 2, 3) as claimed in claim 3, characterized in that the runtime interface (1c, 2c, 3c) is connectable via a network structure to runtime interfaces (1c, 2c, 3c) of other software components (1, 2, 3).

5. The software component (1, 2, 3) as claimed in one of claims 1 to 4, characterized in that said software component furthermore has a presentation means for displaying the function node which is implemented by it, in a control system composition tool.

6. The software component (1, 2, 3) as claimed in one of claims 1 to 5, characterized in that said software component comprises a communication channel between the connection means and the negotiation means for transmitting the connection parameters which have been agreed upon by the negotiation means to the connection means.

7. The software component (1, 2, 3) as claimed in one of claims 1 to 6, characterized in that said software component is a distributed system, in which function means and connection means are separated from the negotiation means and the presentation means.

8. The software component (1, 2, 3) as claimed in one of claims 1 to 7, characterized in that the function nodes are logical nodes in the sense of IEC Standard 61850.

9. The software component (1, 2, 3) as claimed in one of claims 1 to 8, characterized in that the function means comprises a database for storing parameters relating to the function node and/or relating to possible connections.

10. A control system
having a number of software components (1, 2, 3) as claimed in one of claims 1 to 9;
having a control system composition tool for connecting negotiation means of the software components (1, 2, 3); and
having a communication system for connecting the connection means of the software components (1, 2, 3) during a runtime.

11. The control system as claimed in claim 10, characterized in that the communication system is a network or a bus system which is connectable to all the software components (1, 2, 3).

12. The control system as claimed in claim 10 or 11, characterized in that said control system has a negotiation communications system via which the negotiation means and the control system composition tool can communicate with one another.

13. Use of software components (1, 2, 3) for representation of function nodes of application units in a control system with the function nodes each defining an individual control system function in the application units and, in order to achieve a desired functionality of the control system, interact with one another, or are capable of interacting with one another.

14. A method for designing a control system having the following steps:
In a control system composition tool, connecting the negotiation means of at least two software components (1, 2, 3) as claimed in one of claims 1 to 9, whose function means are intended to interact with one another;
By means of the connected negotiation means, determining the compatibility of the at least two function means, which are intended to interact with one another;
Agreeing upon usable connection parameters for data transmission between the function means by means of the connected negotiation means;
Transferring the connection parameter information to the connection means; and
Connecting the connection means on the basis of the connection parameter information.

15. The method as claimed in claim 14, characterized in that connecting the negotiation means is done by means of a graphical user interface, which is capable of displaying representations of the function nodes and displaying the connections established between said function nodes.

16. A computer program product, which can be loaded into an internal memory of a digital data processing means and has computer program code means, which carry out the method as claimed in claim 14 or 15 when they are loaded and run on one or more data processing means.
